(19) United States
(12) Patent Application Publication
(10) Pub. No.: US 2014/0293650 A1
(43) Pub. Date: Oct. 2, 2014

(54) COMPONENT LIGHTING SYSTEM

(71) Applicant: LAUREN ILLUMINATION, LLC, New Philadelphia, OH (US)

(72) Inventors: Dan Knight, Bolivar, OH (US); Charles Jeffrey Laney, Navarre, OH (US); Frank Saho, III, Gnadenhutten, OH (US)

(73) Assignee: LAUREN ILLUMINATION, LLC, New Philadelphia, OH (US)

(21) Appl. No.: 14/194,198

(22) Filed: Feb. 28, 2014

Related U.S. Application Data
(60) Provisional application No. 61/771,632, filed on Mar. 1, 2013.

(51) Int. Cl. F21V 23/06; F21V 23/00

(52) U.S. Cl. CPC F21V 23/06; F21V 23/001
USPC 362/612; 362/640

(57) ABSTRACT

A component lighting system allows for easy installation, removal, and reconfiguration. The system allows individual elements to be readily replaced and allows new components to be readily added to the system. The system can be removed from one installation, broken down into its individual elements, and installed in a new installation with the same or a different configuration. The electric conductors of the system are encased within conduit and junction boxes rated for high voltage systems such as traditional 110V or 220V lighting systems so that the system is compatible with both traditional line voltage AC systems and low voltage DC LED systems. The junction boxes and conduit are plenum-rated such that the system to be installed above a drop ceiling while conforming to most existing building codes.

### CROSS REFERENCE TO RELATED APPLICATIONS

This application claims the benefit of U.S. provisional patent application Ser. No. 61/771,632 filed Mar. 1, 2013; the disclosures of which are incorporated herein by reference.

### BACKGROUND OF THE DISCLOSURE

1. Technical Field

The disclosure relates to lighting systems, lighting system components, power distribution systems for lighting, and methods of installing and using lighting components.

2. Background Information

Lighting systems using light emitting diode (LED) devices as lamps for the system are becoming more common and desired for their benefits over traditional incandescent and fluorescent lamps. Benefits include longevity and power consumption while drawbacks include cost and the unfamiliarity of LED-based lighting systems. Most lighting systems installed in residences are disposed behind or above finished drywall while most commercial lighting systems are hung in open air or used in conjunction with drop ceilings.

The interior spaces of rental properties are often reconfigured to meet the desires of a new tenant. The reconfiguration of interior walls usually requires the reconfiguration of overhead lighting which is often installed in a drop ceiling. Frequent tenant turn-over leads to frequent reconfigurations which, in turn, requires more down time between occupancies and increased costs to the landlord. Such landlords desire a lighting system that lends itself to quick and easy reconfigurations.

Energy cost, durability, and lighting quality are some reasons why landlords and tenants desire LED-based lighting. Edge-lit or side-lit LED panels are known to provide desirable lighting quality while using less electricity than both incandescent and fluorescent lighting. These LED panels include a plurality of light emitting diodes disposed along the thin edge of a diffuser such that light from the LEDs is delivered into the diffuser. The diffuser includes elements that direct the light downwardly into the space being lit by the panel. A drawback for property owners is that an initial installation of low voltage LED lighting prevents a tenant from using high-voltage tradition lighting when such lighting is required or desired by the tenant. Property owners thus do not install a low-voltage LED-based system during the initial construction of building. The experience of a property owner is that a building without traditional high-voltage wiring runs has less value because such runs must be added for certain tenants.

### SUMMARY OF THE DISCLOSURE

The disclosure provides a component lighting system that allows for easy installation, removal, and reconfiguration. The system allows individual elements to be readily replaced and allows new components to be readily added to the system. The system can be removed from one installation, broken down into its individual elements, and installed in a new installation with the same or a different configuration.

The system includes lighting components that connect together with quick connect and quick disconnect locking electrical connectors that do not require tools to make the connections and disconnections. The electric conductors of the system are encased within conduit and junction boxes rated for high voltage systems such as traditional 110V or 220V lighting systems. The electric conductors are sized for both low and high voltage systems. The system thus may be used with both low-voltage and high-voltage lighting systems which provides value to a building owner who elects to install this system. Further, the junction boxes and conduit are plenum-rated such that the system to be installed above a drop ceiling while conforming to most existing building codes.

The disclosure provides a system that may be used with different types and different sizes of lamps. An edge-lit or side-lit LED panel is one exemplary lamp that is used with this system. Side-lit LED panels may be used in combination with drop ceilings. The system may be installed, removed, and reconfigured while only requiring connecting and disconnecting quick-connect electrical connections.

The system may optionally use traditional three conductor wiring for delivering the low-voltage current to the LED panels. The third conductor may be used to relay data throughout the system.

The system removes the LED power supply from the LED panel while incorporating a connector and conduit system that allows the power supply to be readily replaced and allows the power supply to be removed if the system is converted to a high-voltage system.

The system allows multiple LED lamps to be powered by a single power supply. The system allows multiple LED lamps to be dimmed with a single dimming control. A wireless control may be used to turn the system on and off as well as to dim the system.

The disclosure provides a low voltage lighting system with the electric conductors disposed in conduit with quick connectors disposed on each end of each length of conduit. Junction boxes are used between conduits and are provided with different configurations so that different arrangements of the lighting modules may be achieved for different spaces.

The disclosure provides an LED lamp having an integrated junction box with a quick connector for an electrical conduit. In one example, the LED lamp is in the form of an edge lit LED panel with the junction box supporting a quick connect terminal.

The disclosure provides an LED lamp having an integrated junction box with a first incoming quick connector and a second outgoing quick connector to allow electrical power to supply the LED lighting module and flow through the junction box to another conduit to supply another LED lighting module or another junction box. In one example, the LED lamp is in the form of an edge lit LED panel with the junction box supporting two quick connect terminals; one for delivering power to the LED panel and one for allowing power to flow through the junction box to the next link assembly.

The disclosure provides an LED lighting module having an integrated junction box with an incoming quick connector and a communication module. In one example, the LED lamp is an edge lit LED panel with the junction box supporting a quick connect terminal. The communication module provides information through the electrical connectors or through a wireless communication protocol. The disclosure provides a lighting system that allows the individual components of the system to communicate through communication modules. RF, WIFI, or ZigBee communication protocol may be used to gather data from and provide instructions to the individual components of the system.

The disclosure provides LED lamps as described above wherein the lamps are edge lit LED lighting panels for use in drop ceilings. Exemplary sizes include 2×4 foot, 2×2 foot, 1×4 foot, 1×2 foot, and round panels of various diameters.

The disclosure provides a system with color coding of different elements to indicate both the flow of electricity and to indicate which elements are intended to be connected to which other elements.

### BRIEF DESCRIPTION OF THE DRAWINGS

FIG. 1 is a plan view of the top of an exemplary configuration of an LED panel used with the system described in this disclosure.

FIG. 2 is a plan view of the top of another exemplary configuration of an LED panel used with the system described in this disclosure.

FIG. 3 is a perspective view of an exemplary junction box connector assembly disposed on the back of the LED panel.

FIG. 4 is a perspective view of the connector assembly with an optional communication module.

FIG. 5 is a schematic view of a driver assembly.

FIG. 6 is a schematic view of a powered junction box with a connector used to receive the connector of the driver assembly.

FIG. 7 is a schematic view of a link assembly.

FIG. 8 is a top view of an exemplary controller that may be used with the lighting system.

FIG. 9 is a side view of the exemplary controller of FIG. 8.

FIG. 10 is a schematic view of the controller disposed between the driver assembly and a link assembly.

FIG. 11 is a schematic view of an exemplary configuration for the lighting system assembly.

FIG. 12 is a schematic view of another exemplary configuration for the lighting system assembly.

FIG. 13 is a schematic view of another exemplary configuration for the lighting system assembly.

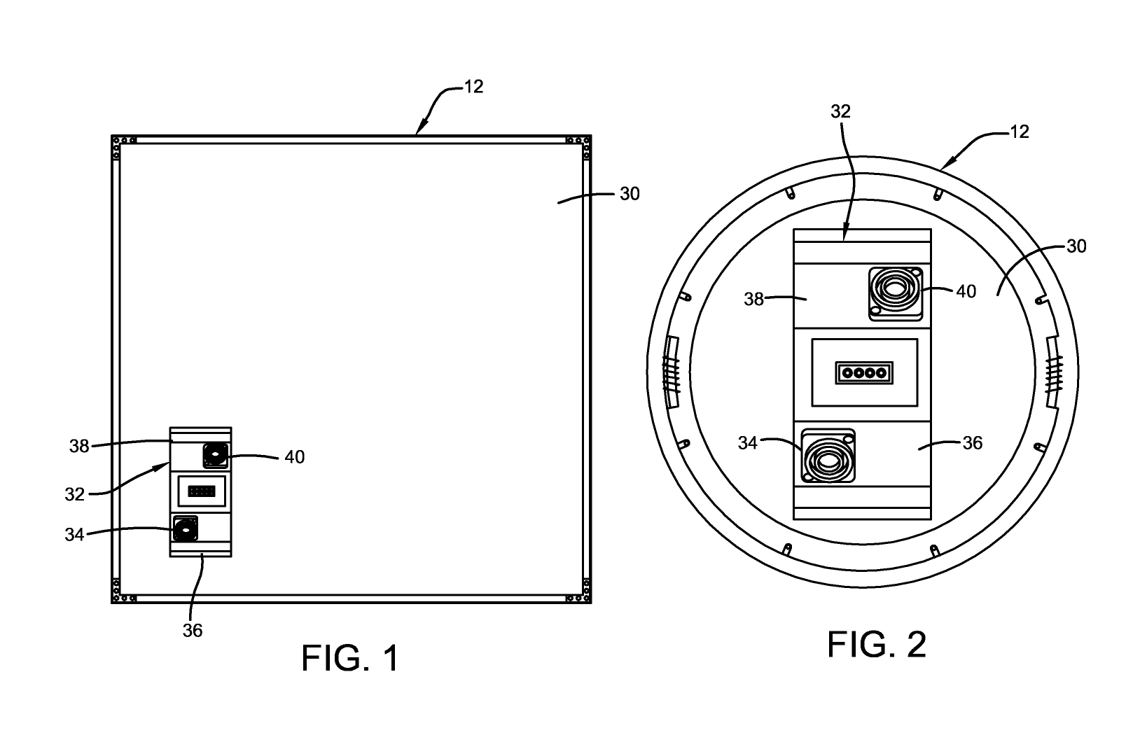

Similar numbers refer to similar parts throughout the specification.

### DETAILED DESCRIPTION OF THE DISCLOSURE

Lighting system 10 is shown in different configurations in the accompanying drawings. System 10 provides for easy installation of the system, removal of the system, reconfiguration of system 10. When system 10 is uninstalled, most of the components of system 10 may be reused in a different installation. System 10 allows individual system elements to be readily replaced and allows new system components to be readily added. System 10 can be removed from one installation, broken down into its individual elements, and installed in a new installation with the same or a different configuration. The components of system 10 and the overall design allow system 10 to be installed above a drop ceiling in compliance with most building codes. Further, system 10 is backwards compatible so that it may be used with traditional incandescent and fluorescent lighting.

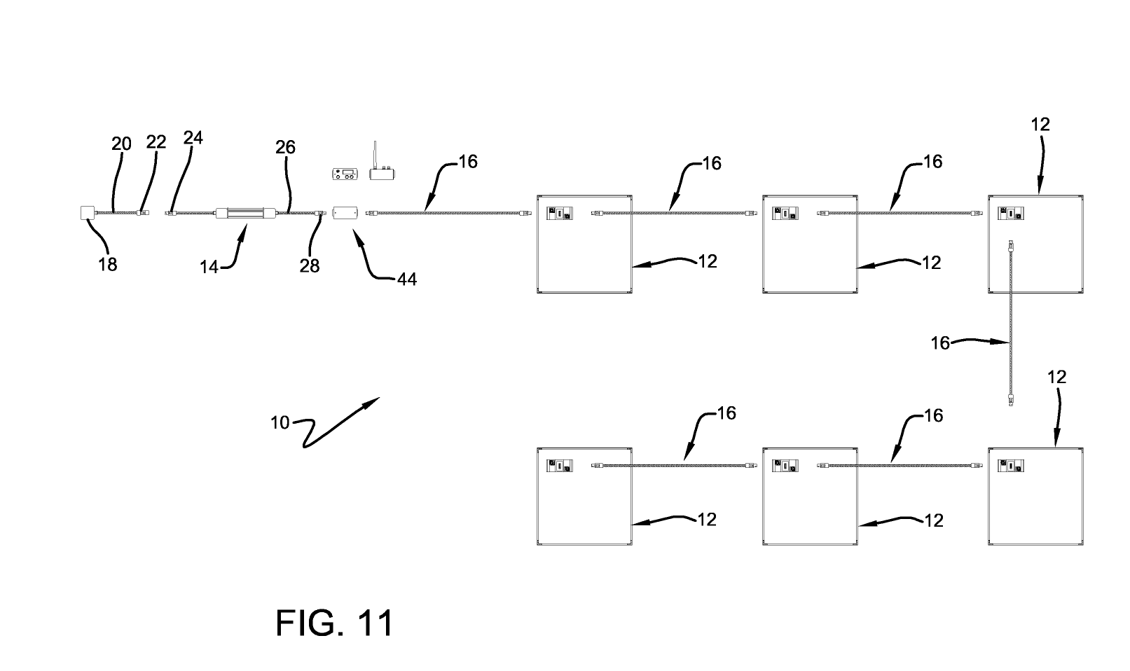

FIGS. 11-13 depict three exemplary configurations for system 10. Each configuration includes at least one lamp 12 powered by a power supply 14 through an electrical link assembly 16. Power supply 14 is configured to receive an incoming line voltage and current and output a direct voltage current. An example of power supply 14 has an output at over 100 Watts. Another example of power supply 14 may have an AC Input—90 to 277 Volt; DC Output—24, 30, or 40 Volt. In system 10, electrical wires supplied with line power are disposed in a junction box 18. A power lead 20 is connected to the electrical wires inside junction box 18 and extends from junction box 18 to support a main power connector 22. Power supply 14 includes a power connector 24 that either connects directly to main power connector 22 or is electrically connected to main power connector 22 through a junction box or an intermediate connector 23. Power connector 24 may be disposed on the end of a lead wire or integrated with the main body of power supply 14. Power supply 14 also includes an output power lead 26 that terminates in a quick connector 28. In the configuration depicted in FIG. 6, main input connector 22 is female and power connector 24 and quick connector 28 are male. These connectors may be the type sold under the powerCON trademark available from Neutrik USA Inc. 4115 Taggart Creek Road Charlotte, N.C., 28208 USA. Power lead 20 and the conduit between connectors 24/28 and the body of power supply 14 are armoured cable as described below. Using connectors on both sides of power supply 14 allows it to be removed from service upon failure and replaced with a new power supply without changing any lamp 12. One power supply 14 may be used to power multiple lamps 30.

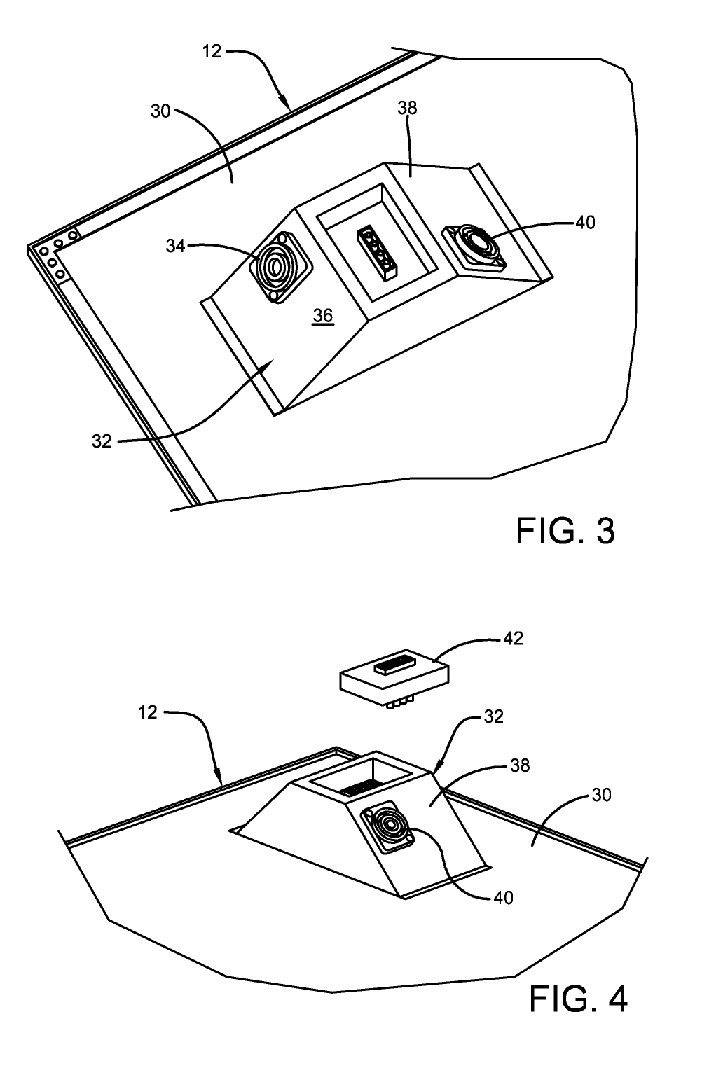

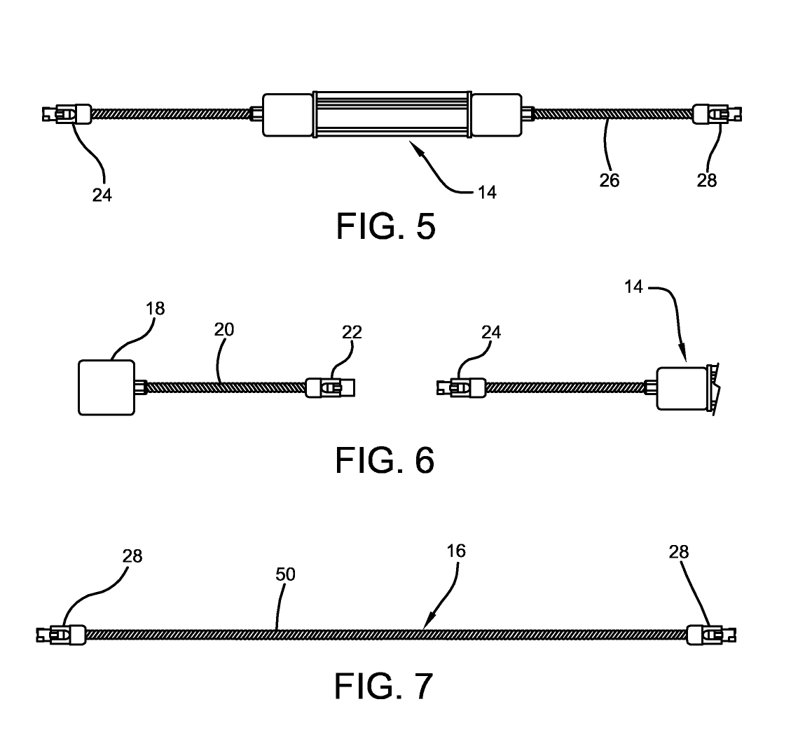

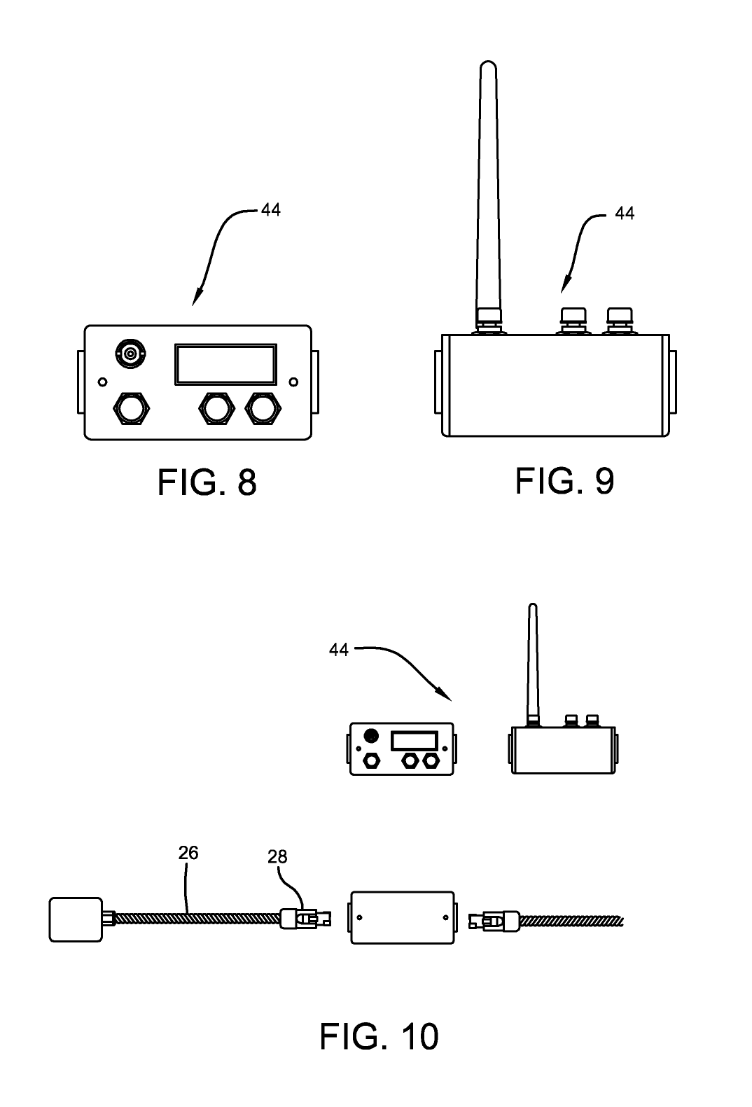

Lamp 12 includes an edge-lit LED panel 30 and an integrated junction box 32. The edge-lit LED lighting panels 30 are for use in drop ceilings. Various lumens, colors, and sizes may be used. Exemplary sizes include 2×4 foot, 2×2 foot, 1×4 foot, 1×2 foot, and round panels of various diameters. Each lamp 12 includes an integrated junction box 32 that carries at least one incoming electrical connector 34 configured to form an electrical connection with a portion of link assembly 16. Electrical connector 34 is in the form of a female terminal such as a terminal sold under the powerCON trademark available from Neutrik USA Inc. Junction box 32 is carried by the body of panel 30 and the electrical connections between connector 34 and the LEDs are enclosed within junction box 32 and the body of panel 30. Junction box 32 defines first 36 and second 38 surfaces with connector 34 disposed on one of these surfaces. In some configurations, a second electrical connector 40 is carried by junction box 32 at the other of these surfaces. Second electrical connector also may be in the form of a female terminal as described above. First 34 and second 40 connectors are electrically connected inside junction box 32 so that electrical power delivered to first electrical connector 34 flows to panel 30 and second electrical connector 40 where it can be transmitted to another link assembly 16. In the configuration shown in FIG. 3, junction box 32 is generally trapezoidal with first 36 and second 38 surfaces being the opposed angled side surfaces that face away from each other. An overload fuse may be located in junction box 32. The overload fuse is sized to protect panel 30 from overload.

Junction box 32 may be configured to receive an optional module 42 as shown in FIG. 4 which allows lamp 12 to be identified by a unique serial number or other identifier. Module 42 may be a simple identifier that communicates identifying information via action or passive communication protocols. The overload fuse also may be used to protect module 42 (discussed below) from overload.

Module 42 may be provided with control or measurement features used with its panel 30. Module 42 may be used to assign unique IP, DMX, DALI, or ZigBee addresses. It may also be used to implement master controls on panel 30 limiting it to a certain light output before being controlled by any other componentry. Several setting are available such as 50 percent light output, 70 percent light output, 85 percent light output. The control features may be configured to communicate with a control computer that communicates directly with module 42 through WIFI. Module 42 also may be configured to communicate with a controller 44 directly connected into system 10.

Module 42 optionally may be used with items used in combination with its panel 30 such as an ambient light sensor or an occupancy sensor that communicate with module 42 and module 42 controls the light provided by its panel 30.

Module 42 also may be configured to monitor the duration and use of its panel 30 and may measure the power usage of its panel 30.

Controller 44 may be electrically connected after power supply 14 to allow the user of system 10 to control the output of system 10 (on/off function or dimming function) or to gather data about system 10. Controller 44 communicates wirelessly with the user and, when configured, to modules 42. The wireless communication may be provided in a variety of communication protocols such as RF, WIFI, ZigBee.

Controller 44 may be used to dim all lamps 12 in system by reducing either voltage or current delivered to each panel 30. One method of dimming each panel individually is to use pulse width modulation. Controller 44 may receive the individual addresses and assignments from controller 42 and send signals via WIFI, RF, DMX, etc and send dimming control to a pulse width modulation controller inside controller 42 where the dimming is controlled.

Controller 44 and modules 42 may transmit information via WIFI that is received by mobile phones of people moving about under system 10. The information may provide location data to the user's phones. The location data may be GPS coordinates or localized information unique to the location of system 10. Large commercial, government, or educational facilities or campuses of buildings may use such a system to provide specific location information to people on the campus. Such location information also may be transmitted to emergency response persons in cases of emergencies.

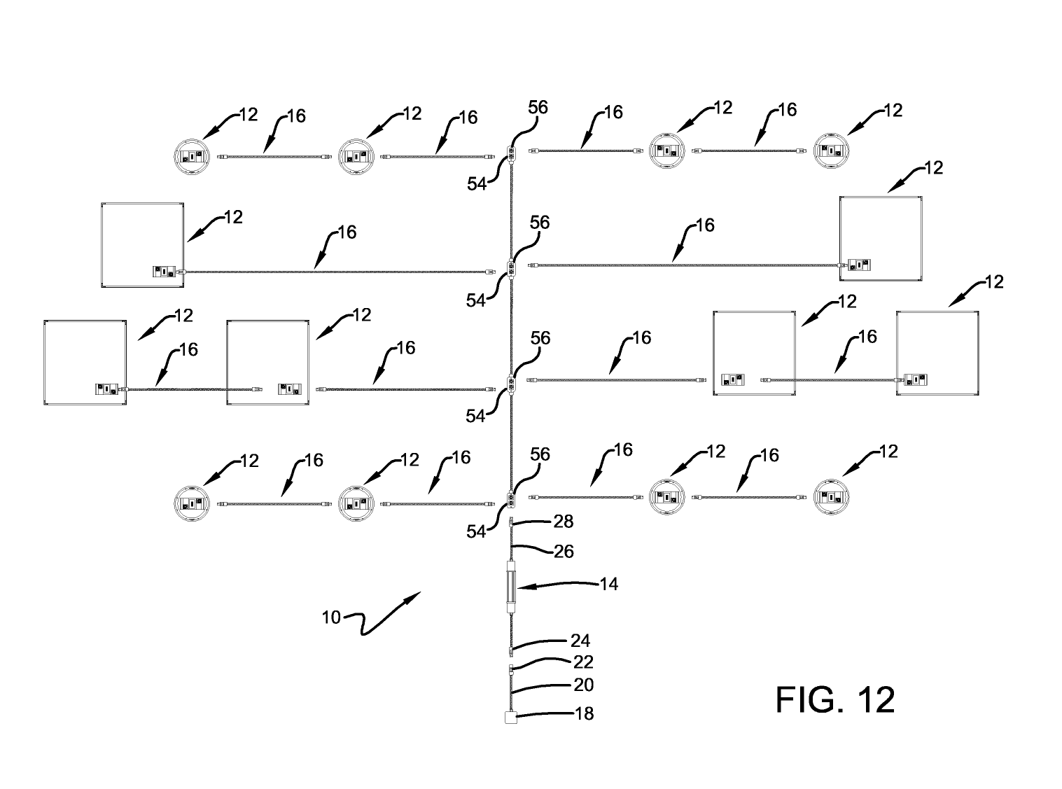

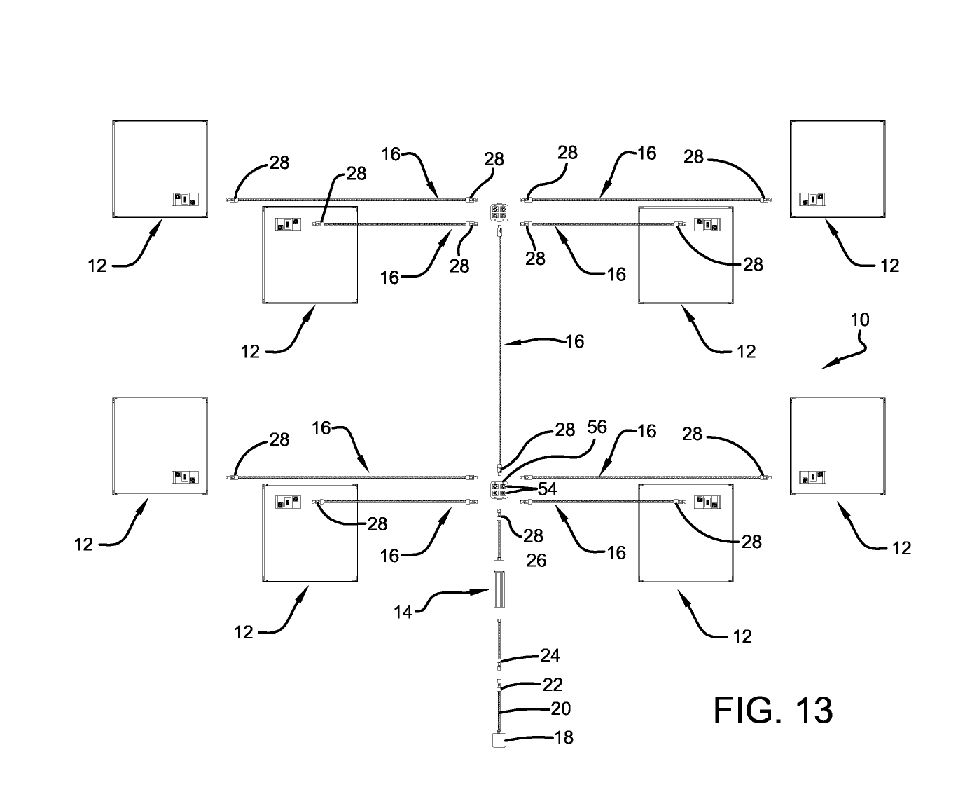

Electrical link assembly 16 (example shown in FIG. 7) includes at least two electrical conductors (not shown) disposed within a conduit 50 that terminates in electrical connectors 28. A ground conductor also may be disposed within conduit 50 and connected to connectors 28. Electrical link assembly 16 is sized and rated for low voltage applications such as direct current transmissions of less than 30 Volt DC and high voltage alternating current transmissions such as 100 to 240 Volt AC. There are at least two conductors within conduit and a third conductor is optional. When the third conductor is present, it may be used to relay data. In one example, conductors disposed within conduit 50 may be 18 gauge or larger wire. In another example, the cables will be minimum of 12 AWG that can be used with traditional incandescent lamps. Conduit 50 itself may be flexible armoured cable such as one that has a flexible metal outer sheath rated for indoor use with traditional lighting. In one example, conduit is MC Cable sizes of three-eighths inch or one-half inch. In one configuration of system 10, each link assembly 16 has a length of six feet or less which complies with many building codes for high voltage systems disposed above drop ceilings. This sizing allows system 10 to be backwards compatible with traditional lighting. Electrical connectors 28 allow link assembly 16 to form an electrical connection with a corresponding electrical connector without the need for tools. Connectors may be quick connect-disconnect connectors that have optional locking features. In this configuration, both connectors 28 on link assembly 16 are male connectors configured to be received in female terminals 34, 40, 54 disposed in junction boxes 32, 56. Junction boxes 56 carry at least two female terminals 54 and may carry four to six terminals 54 to allow for a variety of lamp 12 configurations. Examples are shown in FIGS. 12 and 13. Exemplary connectors 28 are the quick connect and quick disconnect locking connectors and terminals sold under the powerCON trademark available from Neutrik USA Inc. Electrical link assemblies 16 thus allow system 10 to be used with low voltage LED systems and high voltage traditional lighting systems.

An optional feature of system 10 is the color coding of different elements (connectors 28 and terminals 34, 40, and 54) to indicate both the flow of electricity and to indicate which elements are intended to be connected to which other elements. The color coding allows system 10 to be installed without detailed instructions and makes it easy for the components of system 10 to be reconfigured after being removed from an initial installation. System 10 uses three colors. The first color indicates high voltage line power and is used with the two electrical connectors 22 and 24. The second color indicates power flowing into a junction box while the third color indicates power flowing out of a junction box. The first color may be yellow, the second color may be blue and the third color may be gray.

FIG. 11 shows a plurality of lamps 12 chained together. In one example, there are six lamps 12 that are each 51 watt DC for a total of about 300 watts. This system uses a 320 watt DC Driver.

FIGS. 12 and 13 show a plurality of lamps 12 branched from a central supply line assembly. In one example, system 10 includes six lamps 12 that are each 51 watt DC panels combined with eight lamps 12 that are each 12 watt discs for a total of about 396 watts. This system uses a 400 watt DC Driver.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A component lighting system comprising:
a low voltage direct current power supply;
an electrical link assembly including at least two electrical conductors disposed in a conduit and two quick connect electrical connectors electrically connected to the electrical conductors; the electrical link assembly being sized and rated for both low voltage direct current and high voltage alternating current;
one of the two quick connect electrical connectors adapted to selectively connect the electrical link to the low voltage direct current power supply;
a LED lamp; and
the other of the two quick connect electrical connectors adapted to selectively connect the electrical link to the LED lamp.

2. The system of claim 1, wherein the electrical link assembly includes a third electrical conductor.

3. The system of claim 1, wherein the conduit is a flexible metal electrical cable conduit.

4. The system of claim 3, wherein each electrical link has a length of six feet or less.

5. The system of claim 1, wherein the quick connect electrical connectors allow for electrical connections to be made without tools.

6. The system of claim 1, wherein the quick connect electrical connectors include locks.

7. The system of claim 1, wherein portions of the electrical link assembly are color coded.

8. The system of claim 1, wherein the LED lamp is in the form of an edge-lit LED panel adapted for use with a drop ceiling.

9. The system of claim 8, wherein the panel includes a junction box that carries a first quick connect electrical connector that cooperates with one of the quick connect electrical connectors of the electrical link assembly.

10. The system of claim 9, further comprising an electronic identification module carried by the junction box.

11. The system of claim 9, wherein the junction box includes a second quick connect electrical connector that is adapted to cooperate with one of the quick connect electrical connectors of the electrical link assembly.

12. The system of claim 11, wherein the first and second quick connect electrical connectors carried by the junction box are female and the quick connect electrical connectors carried by the electrical link assembly are male.

13. The system of claim 11, further comprising a second LED lamp connected to a second electrical link assembly; and the second electrical link assembly being connected to the second quick connect electrical connector of the junction box of the first LED lamp.

14. A component lighting system comprising:
a low voltage direct current power supply;
a plurality of electrical link assemblies which each includes at least two electrical conductors disposed in a conduit and two quick connect electrical connectors electrically connected to the electrical conductors; the electrical link assembly being sized and rated for both low voltage direct current and high voltage alternating current;
one of the two quick connect electrical connectors adapted to selectively connect the electrical link to the low voltage direct current power supply;
at least a first LED lamp and a second LED lamp;
a junction box carrying at least three quick connect electrical connectors adapted to cooperate with either of the first or second quick connect electrical connectors of the electrical link assemblies;
one of the plurality of electrical link assemblies electrically connecting the direct current power supply to the junction box;
another of the plurality of electrical link assemblies electrically connecting the junction box to the first LED lamp; and
a further of the plurality of electrical link assemblies electrically connecting the junction box to the second LED lamp.

15. The system of claim 14, wherein the quick connect electrical connectors carried by the junction box are female and the quick connect electrical connectors carried by the electrical link assemblies are male.

16. The system of claim 14, wherein each of the LED lamps are in the form of an edge-lit LED panel adapted for use with a drop ceiling; each of the LED lamps include an integrated junction box adapted to receive one of the quick connect electrical connectors of the electrical link assemblies.

17. The system of claim 14, wherein the junction box includes at least four quick connect electrical connectors adapted to cooperate with either of the first or second quick connect electrical connectors of the electrical link assemblies.

18. The system of claim 14, wherein the junction box includes six quick connect electrical connectors adapted to cooperate with either of the first or second quick connect electrical connectors of the electrical link assemblies.

19. A lighting system component; comprising:
a LED lamp assembly that includes an integrated junction box having first and second quick connect electrical connectors; and
the first quick connect electrical connector adapted to receive power that will power the LED lamp unit and the second quick connect electrical connector adapted to receive an electrical link adapted to direct electrical power from the junction box to another component.

20. The component of claim 19, wherein the junction box includes first and second surfaces; the first quick connect electrical connector being disposed at the first surface and the second quick connect electrical connector being disposed at the second surface.

21. The component of claim 19, further comprising an electronic identification module carried by the junction box.

22. The component of claim 19, further comprising an electronic control module carried by the junction box.
